(19) United States
(12) Patent Application Publication
(10) Pub. No.: US 2016/0119817 A1
(43) Pub. Date: Apr. 28, 2016

(54) MOBILE TERMINAL, COMMUNICATIONS CONTROL PROCESSOR, COMMUNICATIONS SYSTEM, AND COMMUNICATIONS METHOD

(71) Applicant: KYOCERA CORPORATION, Kyoto-shi (JP)

(72) Inventor: Yasuo OKAMURA, Yokohama-shi (JP)

(21) Appl. No.: 14/894,500

(22) PCT Filed: May 28, 2014
(86) PCT No.: PCT/JP2014/064194

§ 371 Date: Nov. 27, 2015

(30) Foreign Application Priority Data
May 29, 2013 (JP) 2013-113244

(51) Int. Cl. H04W 28/08; H04W 4/00

(52) U.S. Cl. CPC H04W 28/08; H04W 4/008; H04W 88/06

(57) ABSTRACT

A mobile terminal includes: a communication unit, which is connected to a base station and communicates with the base station; a short-range communication unit, which communicates with an adjacent terminal that includes a tethering unit communicating with the base station; a proxy function unit, which divides a request, received from an application; and a load balancer, which distributes the divided requests to the communication unit and the short-range communication unit. The load balancer performs data communication via the communication unit and data communication via the short-range communication unit and the tethering unit of the adjacent terminal by distributing the divided requests, and the proxy function unit combines data acquired by the load balancer and transmits the combined data to the application.

### TECHNICAL FIELD

The present invention relates to a mobile terminal including a communication unit communicating with a base station, a short-range communication unit, and a tethering unit, a communication control processor, a communication system, and a communication method.

### BACKGROUND ART

In the past, communication lines were not shared by mobile terminals but were independent from each other. With appearing of terminals having both a wide-area wireless communication function such, as 3G or LTE and a short-range communication function such as wireless LAN, a so-called tethering function is being provided. The tethering function. Is a function of connecting own terminal to the Internet using the wide-area wireless communication function, connecting the own terminal to another terminal using the short-range communication function to perform mediating (routing) connection of the another terminal to the Internet.

Patent Literature 1 proposes a configuration in which plural terminals are simultaneously connected to a wireless LAN unit so as to be connected to the Internet via a wireless communication unit and, when the wireless LAN unit is located in a hotspot area, communication of the wireless communication unit is interrupted to connect the hotspot.

Patent Literature 2 proposes a configuration in which condition information for a tethering process is acquired from plural terminals having a tethering function and a tethering terminal suitable for a user is selected based on the acquired condition information.

### CITATION LIST

### Patent Literature

Patent Literature 1: Japanese Unexamined Patent Application Publication No. 2005-217994

Patent Literature 2: Japanese Unexamined Patent Application Publication No. 2012-227610

### SUMMARY OF THE INVENTION

In recent years, services assuming data communication in mobile terminals is being complicated and diversified, and an amount of data transmitted and received has rapidly increased. As a result, there are requirements for a further increase in communication speed.

On the other hand, as disclosed in Patent Literature 1, when communications are performed with sharing a single communication line, the communication speed is limited to an upper limit assigned to a single user. Further, sharing of the communication line causes a decrease in communication speed is necessarily caused for each user, thereby causing a state contrary to the above-mentioned requirements.

Meanwhile, even when an appropriate tethering terminal is selected from plural terminals as described in Patent Literature 2, similarly to Patent Literature 1, there is a possibility that the communication speed is limited to the upper-limit speed of the selected tethering terminal or a decrease in communication speed is caused due to the sharing of the communication line.

In consideration of the above-mentioned circumstances, the present invention is to provide a mobile terminal which can provide a comfortable usage environment and increase a communication speed even when communication lines are congested or large-capacity communication is performed.

According to an aspect of the present invention, a mobile terminal includes: a communication unit, which is connected to a base station and communicates with the base station; a short-range communication unit, which communicates with an adjacent terminal that includes a tethering unit communicating with the base station; a proxy function unit, which divides a request received from an application: and a load balancer, which distributes the divided requests to the communication unit and the short-range communication unit, wherein the load balancer performs data communication via the communication unit and data communication via the short-range communication unit and the tethering unit of the adjacent terminal by distributing the divided requests, and wherein the proxy function unit combines data acquired by the load balancer and transmits the combined data to the application.

In the mobile terminal, the load balancer may distribute the divided requests based on communication-condition information of the mobile terminal and communication-condition information of the adjacent terminal, and the communication-condition information may include at least one of information of a connection state, a communication speed, and a usage condition of the communication unit.

In the mobile terminal, the load balancer may assign the majority of the divided requests to the communication unit of the mobile terminal when the communication-condition information is better than the communication-condition information of the adjacent terminal.

In the mobile terminal, the load balancer may assign ail of the divided requests to the communication unit of the mobile terminal when the communication-condition information is better than the communication-condition information of the adjacent terminal.

According to another aspect of the present invention, a communication control processor is mounted on a mobile terminal having a communication unit, which is connected to a base station and communicates with the base station and a short-range communication unit, which communicates with an adjacent terminal that includes a tethering unit communicating with the base station. The communication control processor includes a proxy function unit, which divides a request received from an application; and a load balancer, which distributes the divided requests to the communication unit and the short-range communication unit, wherein the load balancer performs data communication via the communication unit and data communication via the short-range communication unit and the tethering unit of the adjacent terminal by distributing the divided requests, and wherein the proxy function unit combines data acquired by the load balancer and transmits the combined data to the application.

In the communication control processor, the load balancer may distribute the divided requests based on communication-condition information of the mobile terminal and communication-condition information of the adjacent terminal, and the communication-condition information may include at least one of information of a connection state, a communication speed, and a usage condition of the communication unit.

In the communication control processor, the load balancer may assign the majority of the divided requests to the communication unit of the mobile terminal when the communication-condition information is better than the communication-condition information of the adjacent terminal.

In the communication control processor, the load balancer may assign all of the divided requests to the communication unit of the mobile terminal when the communication-condition information is better than the communication-condition information of the adjacent terminal.

According to another aspect of the present invention, a communication system includes two adjacent terminals, each of the two adjacent terminals including: a communication unit, which is connected to a base station and communicates with the base station; a short-range communication unit, which communicates with the adjacent terminal; a tethering unit, which communicates with the base station via the communication unit in response to a request received from the adjacent terminal via the short-range communication unit; a proxy function unit, which divides a request received from an application; and a load balancer, which distributes the divided requests to the communication unit and the short-range communication unit, wherein the load balancer performs data communication via the communication unit and data communication via the short-range communication unit and the tethering unit of the adjacent terminal by distributing the divided requests, and wherein the proxy function unit combines data acquired by the load balancer and transmits the combined data to the application.

According to another aspect of the present invention, a communication method that is performed by a mobile terminal connected to a base station via a communication unit, the communication method includes: connecting the mobile terminal to an adjacent terminal via a short-range communication unit; dividing a request received from an application communication with an external; distributing the divided requests to the communication unit and the short-range communication unit and acquiring data; and combining data acquired from the communication unit, and the short-range communication unit and transmitting the combined data to the application.

In the communication method, the divided requests may be distributed based on communication-condition information of the mobile terminal and communication-condition information of the adjacent terminal, and the communication-condition information may include at least one of information of a connection state, a communication speed, and a usage condition, of the communication unit.

In the communication method, the majority of the divided requests may be assigned to the communication unit of the mobile terminal when the communication-condition information is better than the communication-condition information of the adjacent terminal.

In the communication method, all of the divided requests may be assigned to the communication unit of the mobile terminal when the communication-condition information is better than the communication-condition information of the adjacent terminal.

According to the present invention, it is possible to provide a mobile terminal which can provide a comfortable usage environment and increase a communication speed even when communication lines are congested or large-capacity communication is performed.

### BRIEF DESCRIPTION OF DRAWINGS

FIG. 1 is a diagram illustrating a mobile terminal and a communication method.

FIG. 2 is a diagram illustrating communication between mobile terminals.

FIG. 3 is a flowchart illustrating an operation of a mobile terminal.

### DETAILED DESCRIPTION OF THE PRESENT INVENTION

Hereinafter, an exemplary embodiment of the present invention will be described in detail with reference to the accompanying drawings. Size, materials, and other specific numerical values described In the exemplary embodiment are merely examples and do not limit the present invention unless particularly mentioned. In the specification and the drawings, elements having substantially the same functions and configurations will be referenced by the same reference signals and description thereof will not be repeated. Elements not directly associated with the present invention are not illustrated.

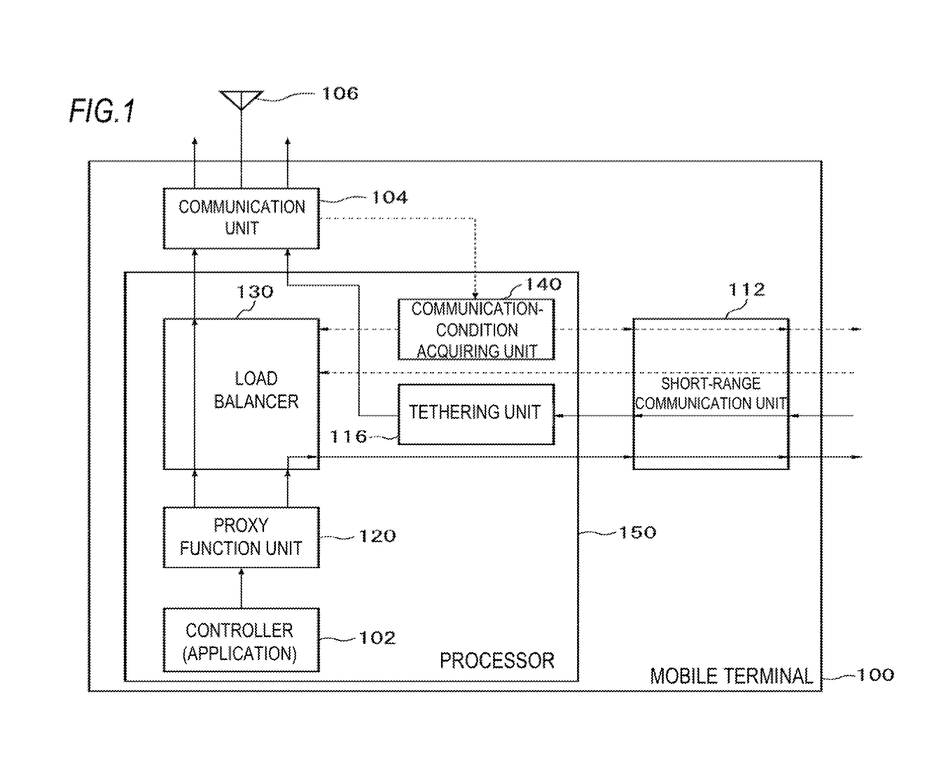

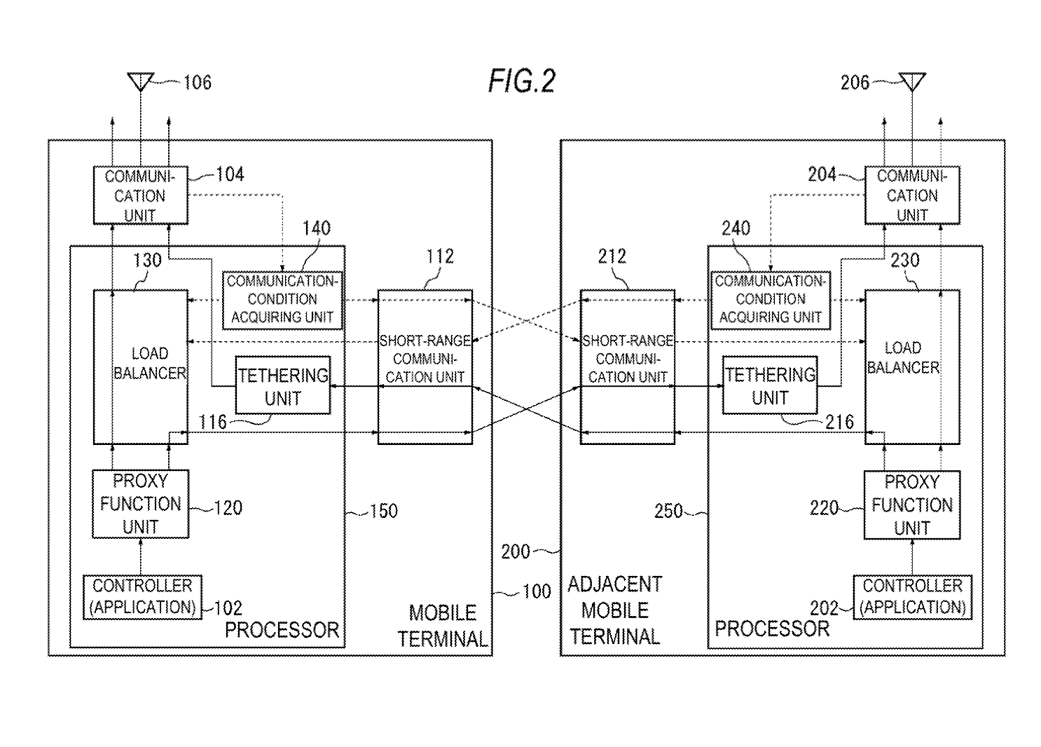

FIG. 1 is a diagram illustrating a mobile terminal and a communication method. FIG. 2 is a diagram illustrating communication between mobile terminals. In the following description, a mobile terminal 100 and a mobile terminal (hereinafter, referred to as an “adjacent terminal 200”) adjacent thereto have the same configuration, where elements of the mobile terminal 100 are referenced by reference numerals in the 100s and elements of the adjacent terminal 200 are referenced by corresponding reference numerals in the 200s. Hereinafter, the functions of the mobile terminal 100 will be described, but the description of the functions of the elements (in the 100s) of the mobile terminal 100 is applied to the elements (in the 200s) of the adjacent terminal 200. The mobile terminal 100 and the adjacent terminal 200 do not have the same configuration necessarily. In the following description, the mobile terminal 100 may be referred to as own terminal.

As illustrated in FIG. 1, the mobile terminal 100 includes a controller 102 that executes an application accompanying communication. Examples of the application accompanying communication include a web browser, a mail application, a news reader, and a message application. The controller 102 specifically has a combination of a CPU, a RAM, and a ROM and the application includes firmware (embedded programs) and additionally-installed programs. The controller 102 sends a request, which is asked for by the application of the mobile terminal 100, to a proxy function unit 120 and receives and sends response data, which is returned in response to the request, to the application. In this embodiment, the controller 102 is constituted as a part of a processor 150, but the controller 102 may be constituted as a unit independent from the processor 150.

The communication unit 104 is connected to a base station not illustrated via an antenna 106 and communicates, with the base station. The communication performed by the communication unit 104 is wide-area wireless communication and examples thereof include 3G, LTE (4G), and WiMAX. As will be described later, the communication unit 104 performs the communication m response to a request sent from an adjacent terminal 200 via a tethering unit 116 as well as a request from the application of the own terminal.

The mobile terminal 100 includes a short-range communication unit 112. The short-range communication unit 112 is, for example, wireless LAN (IEEE 802.11b/g/a/n) or BlueTooth (registered trademark). The short-range communication unit 112 can access as an extension unit an access point of a wireless LAN or the like and can access a network such as the internet. The short-range communication unit 112 serves as an access point when executing of the tethering and can be connected to a short-range communication unit 212 of the adjacent terminal 200 to communicate with each other.

When the short-range communication units 112 and 212 of the terminals 100 and 200 are connected to each other, the tethering unit 116 receives a request from an application of a controller 202 of the adjacent terminal 200. In response to the request, data communication is performed via the communication unit 104 and response data is transmitted to the adjacent terminal 200. In this way, the mobile terminal 100 shares connection of the communication unit 104 to the network and mediates (routes) communication of the mobile terminal 200 (tethering function).

A proxy function unit 120 divides the request received from the application of the controller 102 and transmits and receives the divided requests to and from a load balancer 130. Here, the “divide” means that one request is divided into plural sub-requests. For example, when a request for opening a web page is given, the proxy function unit 120 can divide the request into sub-requests in the units of text, frame, or image. In even case of data such as streaming data or file transfer protocol (FTP) in which a reading start position and a reading data length can be designated, a piece of data can be divided into sub-requests by arbitrary units.

The load balancer 130 distributes the requests divided and transferred from the proxy function unit 120 to the communication unit 104 and the short-range communication unit 112 and performs data communication with a server not illustrated via the communication unit 104. Response data acquired from the server is transmitted to the proxy function unit 120 again.

That is, in the background art, only one of the communication unit 104 and the short-range communication unit 112 could be used as a communication path, but the communication unit 104 and the short-range communication unit 112 can he simultaneously used by the load balancer 130.

The proxy function unit 120 combines the data acquired by the load balancer to construct a series of response data and transmits the response data to the application of the controller 102.

In the mobile terminal and the communication method according to this embodiment, according to the cooperation with the adjacent terminal 200, load balancing and parallel processing can be performed with using a communication line of the mobile terminal 100 and a communication line of the adjacent terminal 200, and it is thus possible to shorten a communication time, that is, to increase a communication speed.

For example, if a request from the application is divided into several sub-requests and halves of the sub-requests are respectively transmitted via two communication lines of the terminals 100 and 200, download of response data can be completed within a half time as a whole by simple calculation. That is, communication can be performed at a double speed (a line concentration effect based on a line switching system) and it is thus possible to achieve an increase in communication speed.

For example, when the terminals 100 and 200 are different from each other in telecommunication carrier (carrier) or communication system (3G, LTE, or the like), the terminals 100 and 200 adjacent to each other may have different communication-conditions. In this case, by employing the configuration according to this embodiment, since there is a possibility that one mobile terminal can suitably perform the communications, it is possible to provide a more comfortable usage environment.

A communication-condition acquiring unit 140 illustrated in FIG. 1 acquires communication-condition information including information of a connection state, a communication speed, or a usage condition from the communication unit 104. The connection state may include a information whether it is being connected, field intensity (RSSI), an SN ratio, a bit error rate, or a frame error rate. The communication speed may be a negotiated communication speed or may be an effective speed, which is obtained by dividing an amount of data transferred by an elapsed time. The usage condition can report what queue (transmission data queue) is accumulated in a buffer. The communication-condition acquiring unit 140 transmits the communication-condition information to the load balancer 130 of the own terminal, and the adjacent terminal 200.

The load balancer 130 compares the communication -condition information of the own terminal and the adjacent terminal 200 and distributes the sub-requests so as to send the sub-requests via the empty communication line. Since the requests are transmitted from different terminals (different IP addresses) from the viewpoint of the server, response data is returned to the terminals having transmitted the sub-requests. In this way, by distributing sub-requests depending on the communication-conditions of the communication units 104 and 204, it is possible to smoothly perform communication and thus to achieve a further increase in communication speed.

When the communication-condition of the communication unit 104 is better than the communication-condition of the communication unit 204, the load balancer 130 may be configured to assign, the majority of the divided sub-requests to the communication unit 104 of the mobile terminal 100. When the communication-condition of the communication unit 104 is better than the communication-condition of the communication unit 204, the load balancer 130 may be configured to assign all of the divided sub-requests to the communication unit 104 of the mobile terminal 100.

In this embodiment, as illustrated in FIG. 1, the load balancer 130, the tethering unit 116, the proxy function unit 120, and the communication-condition acquiring unit 140 may be combined into a processor 150 (communication control processor) which is mounted on a terminal.

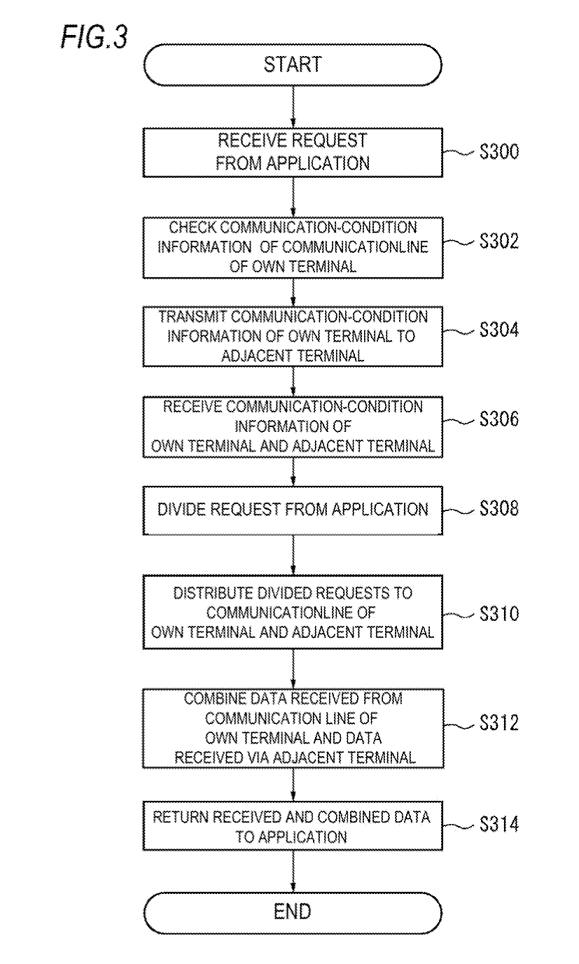

FIG. 3 is a flowchart illustrating an operation of the mobile terminal. First, when a request is received from the application of the controller 102 (step S300), the proxy function unit 120 transmits the request to the load balancer 130.

The load balancer 130 refers to the communication-condition acquiring unit 140 for the communication-condition information of the own terminal (mobile terminal 100) (step S302). The communication-condition acquiring unit 140 acquires the communication-condition information from the communication unit 104 and transmits the acquired communication-condition information to the load balancer 130 of the own terminal.

The communication-condition acquiring unit 140 transmits the communication-condition information of the own terminal acquired from the communication unit 104 to the load balancer 230 of the adjacent terminal 200 (step S304).

The load balancer 130 receives the communication-condition information of the own terminal and the adjacent terminal 200 as an opponent from the communication-condition acquiring units 140 and 240 (step S306). As a result, the load balancers 130 and 230 of the terminals 100 and 200 grasp the communication-conditions of the own terminal and the opposite terminal by exchanging the communication-condition information with each other.

The proxy function unit 120 divides the request received From the application info sub-requests and transmits the sub-requests to the load balancer 130 (step S308).

The load balancer 130 distributes the divided sub-requests to the communication unit 104 and the short-range communication unit 112 (that is, the communication unit 204 of the adjacent terminal 200) of the own terminal (step S310). When response data to the distributed sub-requests is transmitted from the communication units 104 and 204, the load balancer transmits the data to the proxy function unit 120.

The proxy function unit 120 combines the response data received from the load balancer 130 to construct a series of response data (step S312). A series of response data is response data corresponding to the request transmitted from the application. Then, the proxy function unit 120 transmits the combined response data to the application of the controller 102 (step S314).

While the exemplary embodiment of the present invention has been described above with reference to the accompanying drawings, the present invention is not limited to the embodiment. Those skilled in the art can think out various alterations or modifications without departing from the appended claims and will understand that the alterations or modifications belong to the technical scope of the present invention.

While the present invention has been described in detail with reference to a specific embodiment, it will be apparent to those skilled in the art that various alterations or modifications can be made.

This application is based on Japanese Patent Application No. 2013-113244, filed on May 29, 2013, the disclosure of which is incorporated herein by reference in its entirety.

### INDUSTRIAL APPLICABILITY

The present invention is applicable as a mobile terminal including a communication unit communicating with a base station, a short-range communication unit, and a tethering unit, a communication control processor, a communication system, and a communication method.

### REFERENCE SIGNS LIST

100 mobile terminal

200 adjacent terminal (adjacent mobile terminal)

102, 202 controller

104, 204 communication unit

106, 206 antenna

112, 212 short-range communication unit

116, 216 tethering unit

120, 220 proxy function unit

130, 230 load balancer

140, 240 communication-condition acquiring unit

150, 250 processor

1. A mobile terminal comprising;
a communication unit, which is connected to a base station and communicates with the base station;
a short-range communication unit, which communicates with an adjacent terminal that includes a tethering unit communicating with the base station;
a proxy function unit, which divides a request received from an application; and
a load balancer, which distributes the divided requests to the communication unit and the short-range communication unit,
wherein the load balancer performs data communication via the communication unit and data communication via the short-range communication unit and the tethering unit of the adjacent terminal by distributing the divided requests, and
wherein the proxy function unit combines data acquired by the load balancer and transmits the combined data to the application.

2. The mobile terminal according to claim 1,
wherein the load balancer distributes the divided requests based on communication-condition information of the mobile terminal and communication-condition information of the adjacent terminal, and
wherein the communication-condition information includes at least one of information of a connection state, a communication speed, and a usage condition of the communication unit.

3. The mobile terminal according to claim 2,
wherein the load balancer assigns the majority of the divided requests to the communication unit of the mobile terminal when the communication-condition information is better than the communication-condition information of the adjacent terminal.

4. The mobile terminal according to claim 2,
wherein the load balancer assigns ail of the divided requests to the communication unit of the mobile terminal when the communication-condition information is better than the communication-condition information of the adjacent terminal.

5. A communication control processor that is mounted on a mobile terminal having a communication unit, which is connected to a base station and communicates with the base station and a short-range communication unit, which communicates with an adjacent terminal that includes a tethering unit communicating with the base station, the communication control processor comprising:
a proxy function unit, which divides a request received from an application; and
a load balancer, which distributes the divided requests to the communication unit and the short-range communication unit,
wherein the load balancer performs data communication via the communication unit and data communication via the short-range communication unit and the tethering unit of the adjacent terminal by distributing the divided requests, and
wherein the proxy function unit combines data acquired by the load balancer and transmits the combined data to the application.

6. The communication control processor according to claim 5,
wherein the load balancer distributes the divided requests based on communication-condition information of the mobile terminal and communication-condition information of the adjacent terminal, and
wherein the communication-condition information includes at least one of information of a connection state, a communication speed, and a usage condition of the communication unit.

7. The communication control processor according to claim 6,
wherein the load balancer assigns the majority of the divided requests to the communication unit of the mobile terminal when the communication-condition information is better than the communication-condition information of the adjacent terminal.

8. The communication control processor according to claim 6,
wherein the load balancer assigns all of the divided requests to the communication unit of the mobile terminal when the communication-condition information is better than the communication-condition information of the adjacent terminal.

9. A communication method that is performed by a mobile terminal connected to a base station via a communication unit, the communication method comprising;
connecting the mobile terminal to an adjacent terminal via a short-range communication unit;
dividing a request received from an application communication with an external;
distributing the divided requests to the communication unit and the short-range communication unit and acquiring data; and
combining data acquired from the communication unit and the short-range communication unit and transmitting the combined data to the application.

10. The communication method according to claim 9,
wherein the divided requests are distributed based on communication-condition information of the mobile terminal and communication-condition information of the adjacent terminal, and
wherein the communication-condition information includes at least one of information of a connection state, a communication speed, and a usage condition of the communication unit.

11. The communication method according to claim 10,
wherein the majority of the divided requests is assigned to the communication unit of the mobile terminal when the communication-condition information is better than the communication-condition information of the adjacent terminal.

12. The communication method according to claim 10,
wherein ail of the divided requests are assigned to the communication unit of the mobile terminal when the communication-condition information is better than the communication-condition information of the adjacent terminal.
